(19) United States
(12) Patent Application Publication
(10) Pub. No.: US 2005/0063454 A1
(43) Pub. Date: Mar. 24, 2005

(54) Thermometer having a disposable temperature probe

(76) Inventor: Chu-Yih Yu, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/980,041

(22) Filed: Nov. 3, 2004

Related U.S. Application Data
(63) Continuation-in-part of application No. 10/413,163, filed on Apr. 14, 2003.
Application No. 10/413,163 is a continuation-in-part of application No. 10/050,122, filed on Jan. 18, 2002, now abandoned.
(63) Continuation-in-part of application No. 10/274,220, filed on Oct. 18, 2002.

(51) Int. Cl. G01K 7/00; G01K 1/00

(52) U.S. Cl. 374/208; 374/163; 374/186

(57) ABSTRACT

According to one aspect of the present invention, a thermometer with a disposable temperature probe is disclosed. The disposable temperature probe is made up of a hollow tip member, a thermal sensor and a transmission means. The hollow tip member has a thermal contact surface surrounding a hollow cavity and the thermal sensor is mounted on the inside of the contact surface. The thermal sensor senses the temperature of the thermal contact surface and generates a temperature signal. The transmission means is used to transmit the temperature signal. The thermometer also includes a temperature recorder having a slot for the installation of the disposable temperature probe. The temperature recorder is provided with a latch to fasten the disposable temperature probe.

### CROSS-REFERENCE TO RELATED APPLICATION

The present application is a continuation-in-part of U.S. patent application having Ser. No. 10/413,163 filed on Apr. 14, 2003, which is a continuation-in-part of U.S. patent application having Ser. No. 10/050,122 filed on Jan. 18, 2003, the disclosures of which are hereby incorporated by reference herein.

The present application is also a continuation-in-part of U.S. patent application having Ser. No. 10/274,220 filed on Oct. 18, 2002, which is hereby incorporated by reference in its entirety.

### BACKGROUND OF THE INVENTION

1. Field of the Invention

The invention relates to the field of thermometers. More particularly, the invention relates to a disposable thermometer probe works in conjunction with a temperature record for measurement of a patient's temperature, although it is equally applicable to other temperature measurement fields.

2. Description of the Related Art

U.S. Pat. No. 4,488,560, issued Dec. 18, 1984 to Takatsugu, discloses a menstruation period counter of a card shape. As shown in FIG. 1, a LCD indicator 9 includes a calendar indicator A showing a calendar of each month and an illustrator B showing the basal bodily temperature chart time, day, and the bodily temperature.

A temperature measuring sensor 1 is directly bonded with a sensor chip and connected via three lead wires to the counter body. A sensor heating circuit 3 appropriately heats the temperature of the sensor in advance to shorten the measurement time. When a switch 4a, disposed on a front face of the card shape counter, is pushed down, a circuit in a switch matrix 4 is formed, and a microprocessor 5 outputs a control signal of the temperature measuring range and proceeds to a bodily temperature measuring routine. A pre-amplifier 6 appropriately effects DC amplification on an analog signal sent from the temperature measuring sensor 1 and feeds it to an A/D converter 7. An A/D converter control circuit 8 controls the standard voltage of the A/D converter 7 and sets the temperature measuring range between 35° C. and 42° C. The output of the A/D converter 7 is directly sent to the microprocessor 5. The output of the microprocessor 5 includes the LCD indicating digit signal, LCD indicating segment signal, switching digit signal, piezo-buzzer drive signal, and sensor control signal. As depicted, a LCD drive circuit 10, a liquid crystal vibrator 11 and a piezo-buzzer 12 are connected to the microprocessor 5, respectively.

To accelerate the time response, the prior art employs the sensor heating circuit 3 to heat the measuring sensor 1 in advance such that the measurement time is reduced. However, the prior art instrument has some drawbacks such as high circuit complexity, high energy consumption and high production cost due to its built-in heating circuit 3. Furthermore, the temperature measuring sensor 1 is not disposable so it has to be reused again and again. Hence, the prior art is not applicable to different people for the sanitary issue.

### SUMMARY OF THE INVENTION

It is an object of the present invention to provide a thermometer with a disposable temperature probe to overcome the disadvantages of the prior art.

With the disposable temperature probe, the sanitary issue is greatly improved and the thermometer of the invention is thus applicable to different people. According to one aspect of the invention, the thermometer is comprised of a disposable temperature probe and a temperature recorder. The disposable temperature probe is a flat or tubular shape, and offers a fast time response. Its thermal sensor is designed to reach an equilibrium temperature immediately, which leads to reduction of time response up to 50% by experiments. The thermometer of the invention can effectively shorten the measurement time without the use of a heater, therefore, the circuit complexity is simplified and the production cost is reduced.

The temperature recorder includes a slot for the installation of the disposable temperature probe, and secures the disposable temperature probe by a latch. When performing measurement, the latch causes the disposable temperature probe not to fall off or prevents it from being eaten accidentally. To approach the equilibrium temperature instantly, the entire wires, or at least a portion of each wire, within a hollow cavity, are preferably bonded to the inside of a thermal contact surface. In close contact with flesh in a body cavity, the thermal contact surface serves as a heater such that the wires come to the equilibrium temperature rapidly. Thus, the measurement time is dramatically reduced. Note that the wires are bonded using an insulating material with good thermal conductivity. Preferably, the wires, within the hollow cavity, are bonded to the inside of the thermal contact surface with epoxy resin.

According to the present invention, the above objects are resolved with a thermometer having a disposable temperature probe. The disposable temperature probe is made up of a hollow tip member, a thermal sensor and a transmission means. The hollow tip member has a thermal contact surface surrounding a hollow cavity. The thermal sensor is mounted on the inside of the contact surface, and it senses the temperature of the thermal contact surface to generate a temperature signal. Note that the disposable temperature probe is a flat or tubular shape. The transmission means is used to transmit the temperature signal. Preferably, at least a portion of the transmission means within the hollow cavity is firmly bonded to the inside of the thermal contact surface. The thermometer also includes a temperature recorder having a slot for the installation of the disposable temperature probe. The temperature recorder is provided with a display means connected to the transmission means. The display means shows a temperature corresponding to the temperature signal. Further, the temperature recorder includes a latch to fasten the disposable temperature probe and a container to hold at least one disposable temperature probe.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is block diagram of a thermometer according to the prior art;

FIGS. 2A and 2B are diagrams showing a flat disposable temperature probe according to the invention;

FIG. 3A is a perspective view of a temperature reader according to the invention;

FIGS. 3B-3D are diagrams showing according to the invention;

FIG. 4 is a perspective view of a temperature recorder according to the invention;

FIG. 5 is a temperature chart shown on a display of FIG. 4; and

FIGS. 6A-6C are diagrams showing a tubular disposable temperature probe according to the invention.

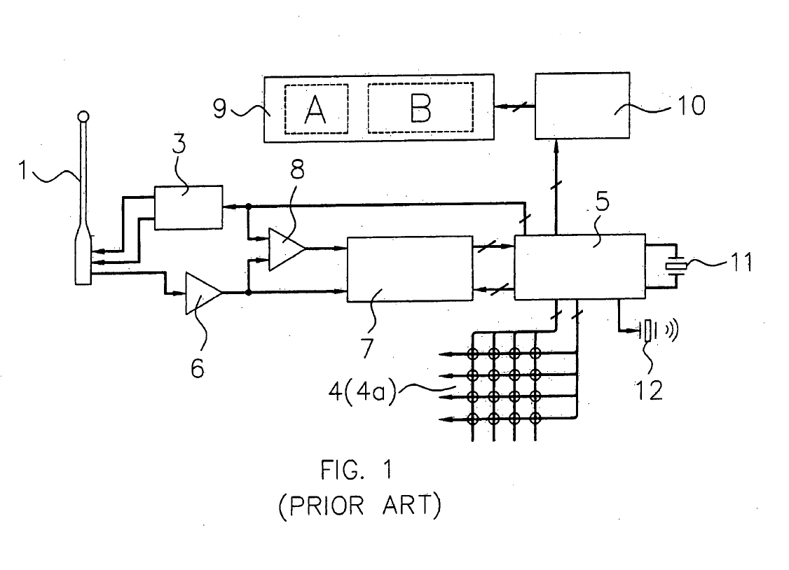

### DETAILED DESCRIPTION OF THE INVENTION

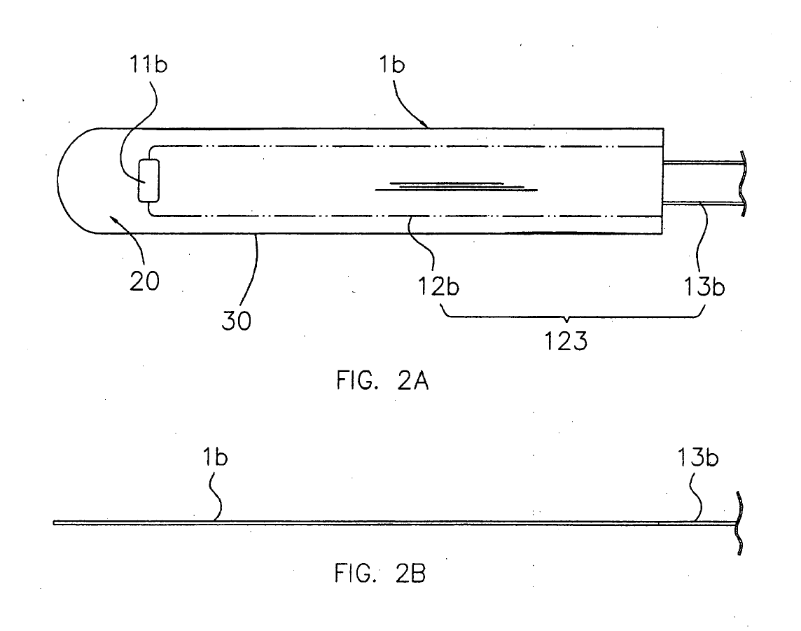

One embodiment of a disposable temperature probe is illustrated in FIGS. 2A and 2B. The flat disposable temperature probe (or test strip) 1b includes a hollow tip member 20 having a thermal contact surface 30. A thermal sensor 11b is mounted on the inside of the thermal contact surface 30. It senses the temperature of the thermal contact surface 30 and generates a temperature signal. A transmission means 123 is connected to the thermal sensor 11b to transmit the temperature signal. At least a portion of the transmission means 123 is preferably bonded to the inside of the thermal contact surface 30. The transmission means 123 is comprised of a set of wires 12b and a connector 13b. The wires 12b are arranged in the hollow tip member 20. To reduce the measurement time, a portion of the wires 12b is bonded to the inside of a thermal contact surface 30 in accordance with the invention. The connector 13b is electrically coupled to the set of wires 12b and extended out of the disposable temperature probe 1b in order to connect to a temperature recorder. The flat disposable temperature probe 1b has a thickness of approximately 0.3 mm, which results in a better thermal conductivity. Thus, the disposable temperature probe 1b approaches an equilibrium temperature quickly and its measurement time is reduced to 3 seconds.

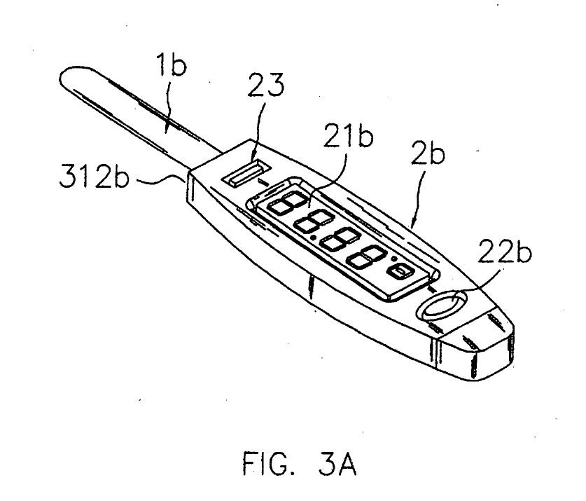

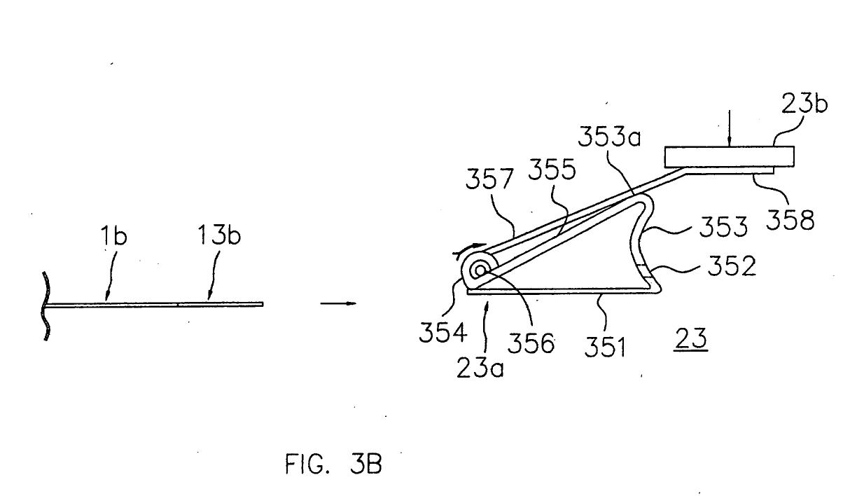

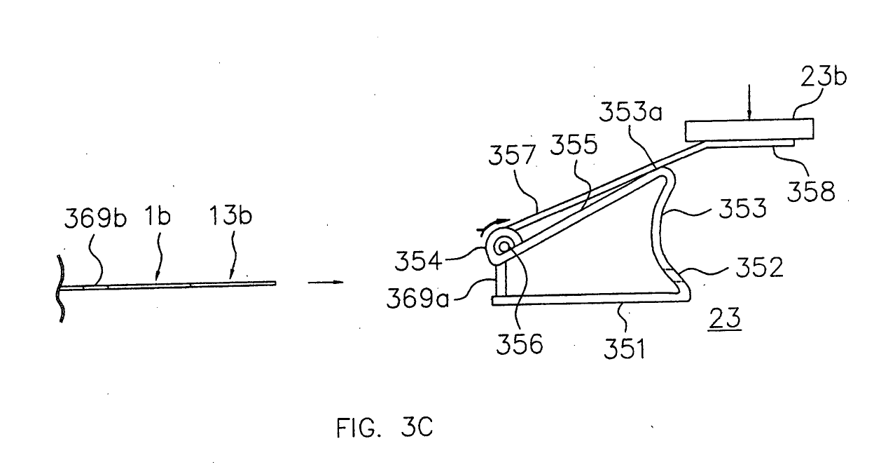

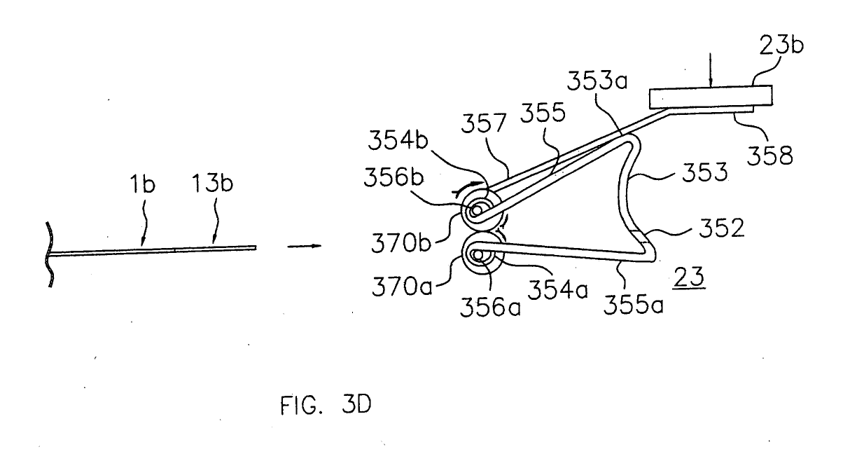

Referring to FIG. 3A, a temperature reader 2b has a slot 312b for the installation of the disposable temperature probe 1b. The temperature reader 2b is provided with a display means 21b connected to the connector 13b (not shown) of the transmission means 123. The display means 21b receives the temperature signal and shows a corresponding temperature. Also, the temperature reader 2b has a switch 22b to turn on and off the display means 21b. In this case, the temperature reader 2b further includes a latch 23 to fasten the disposable temperature probe 1b. Turning now to FIG. 3B, the latch 23 is made up of a lock switch, a lock unit, a pivot rod, a driving arm and a pressing portion. The lock unit includes a base portion 351, an upper portion 355, and a bending portion 353 connected between the base and the upper portions. The bending portion 353 has a wire hole 352 to allow the connector 13b of the transmission means 123 to be passed through it. The pivot rod 356 is covered with a sleeve 354. As depicted, the sleeve 354 is coupled with the upper portion 355 of the lock unit. The driving arm 357 is inserted into the sleeve 354 and engaged with the pivot rod 356. The pressing portion 358 is horizontally extended from the driving arm 357 to bear the lock switch 23b.

The driving arm 357, the upper and the bending portions 355, 353 are connected together at a contact end to form a fulcrum 353a. By releasing the lock switch 23b, the lock unit is closed to lock the slot 312b of the temperature reader 2b. When the lock switch 23b is pushed down, the pressing portion 358 is moved downward to lift the pivot rod 356 engaged with the driving arm 357 by the fulcrum 353a and the bending portion 353 of the lock unit is also bended, thereby forming an aperture 23a between the upper and the base portions of the lock unit. In the meantime, the disposable temperature probe 1b can be placed in the aperture 23a and the connector 13b is electrically coupled to the display means 21b through the wire hole 352. When the lock switch 23b is released, the aperture 23a is closed to firmly secure the disposable temperature probe 1b.

FIG. 3C illustrates an alternative embodiment of the latch 23. The main difference between FIGS. 3A and 3C is a pin 369a vertically protruded from an opening end of the upper or the base portion of the lock unit, and there exists a pin hole 369b located at a corresponding position of the disposable temperature probe 1b. When pressing the lock switch 23b, the disposable temperature probe 1b can be inserted into an aperture formed by opening the upper and the base portions of the lock unit as described above. When releasing the lock switch 23b, the disposable temperature probe 1b is locked by putting the pin 369a inside the pin hole 369b. As well, the connector 13b is electrically coupled to the display means 21b through the wire hole 352.

FIG. 3D illustrates yet another embodiment of the latch 23. The main difference between FIGS. 3A and 3D is the additional rollers 370a and 370b. Preferably, these rollers 370a and 370b have rough surfaces to increase friction. A pivot rod 356a covered with a sleeve 354a is disposed at the base portion 355a. Further, the sleeve 354a is coupled with the base portion 355a. A pivot rod 356b and a sleeve 354b are similar to the embodiment of FIG. 3A. The rollers 370a and 370b surround the pivot rods 356a and 356b, respectively, to roll into the disposable temperature probe 1b. Notably, the rollers 370a and 370b are eccentric to the pivot rods 356a and 356b, respectively. In this way, the rollers 370a and 370b cannot be rolled in reverse to prevent the disposable temperature probe 1b from slip out. When measurement is done, the disposable temperature probe 1b can be taken out by pressing the lock switch 23.

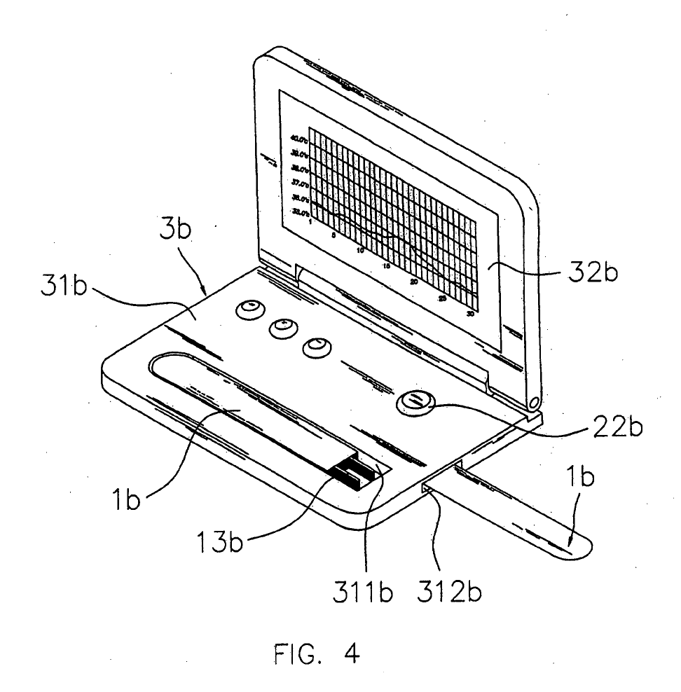

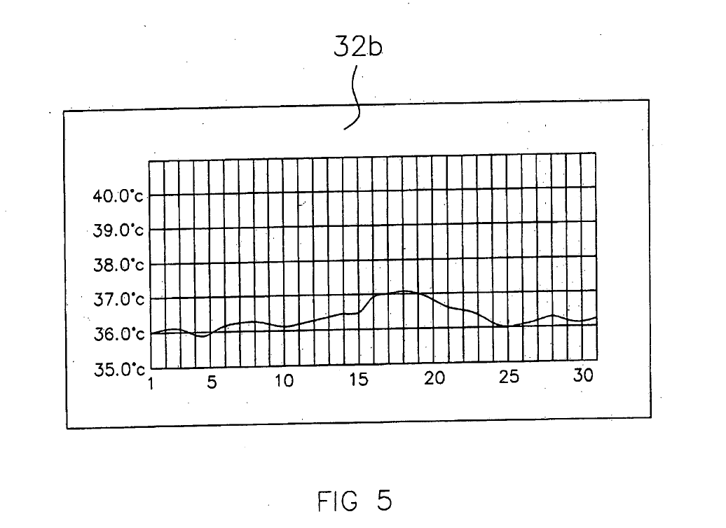

Referring to FIG. 4, a card shape temperature recorder 3b of the invention is illustrated. The temperature recorder 3b includes a recorder body 31b and a slot 312b. As depicted, the slot 312b is disposed on the recorder body 31b for the installation of the disposable temperature probe 1b. The temperature recorder 3b is provided with a display means 32b connected to the connector 13b (not shown) of the transmission means 123. The display means 32b receives the temperature signal and shows a corresponding temperature. A switch 22b is used to turn on and off the display means 32b. Additionally, the temperature recorder 3b is equipped with a container 311b to hold at least one disposable temperature probe. FIG. 5 illustrates a bodily temperature chart measured by the temperature recorder 3b of the invention. It is also applicable to the basal bodily temperature chart for women.

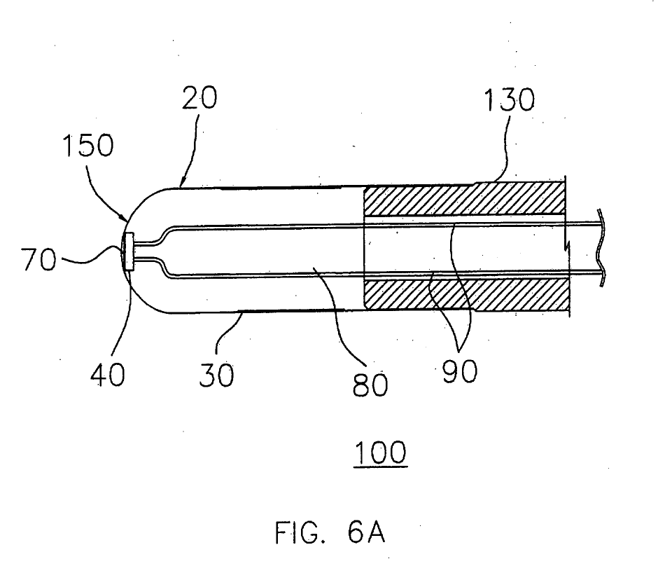

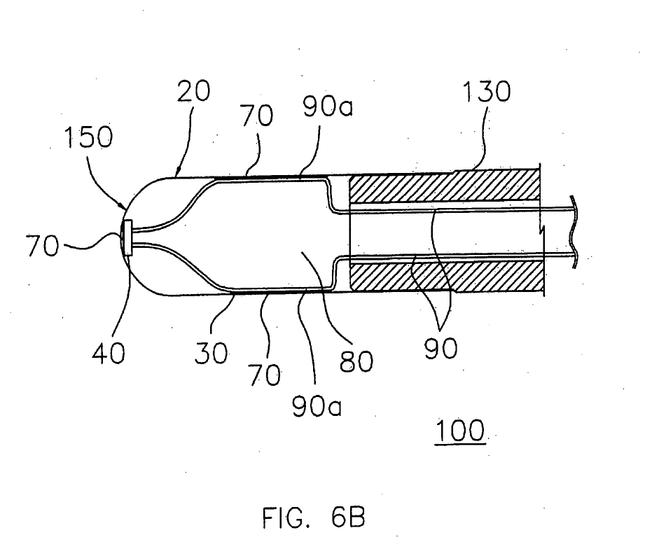

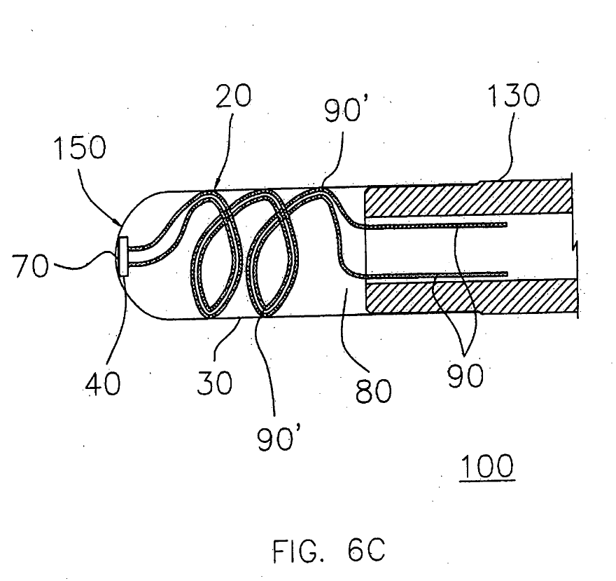

FIGS. 6A through 6C illustrate three embodiments of the disposable temperature probe. As shown in FIG. 6A, a tubular temperature probe 100 includes a probe body 130 and a hollow tip member 20 secured to the probe body 130. The hollow tip member 20 has a thermal contact surface 30 surrounding a hollow cavity 80. A thermal sensor 40 is placed at the end 150 of the hollow tip member 20 and mounted on the inside of the thermal contact surface 30. The thermal sensor 40 senses the temperature of the thermal contact surface 30 and produces a temperature signal. A set of wires 90 is connected to the thermal sensor 40 to transmit the temperature signal. Referring to FIG. 6B, each wire 90 has at least a portion 90a within the hollow cavity 80 that is bonded to the inside of the thermal contact surface 30 with heat conductive glue 70. Referring to FIG. 6C, wires 90′ within the hollow cavity 80 are bonded to the inside of the thermal contact surface 30 in a spiral form with the heat conductive glue 70 for enhancement of the conductive effect.

In the aforementioned embodiments of FIGS. 6A-6C, the hollow tip member 20 is preferably made of metal with high thermal conductivity, such as silver, platinum, or stainless steel. The hollow tip member 20 is made in the form of a flat or tubular shape, and it has a domed, hemispherical or hemiellipsoid shaped end. Additionally, the preferred thermal sensor 40 is a thermistor. The wires 90 and the thermistor 40 are both adhered on the inside of the thermal contact surface 30 of the hollow tip member 20 with the heat conductive glue 70. According to the invention, the glue 70 is an insulating material with good thermal conductivity, e.g., epoxy resin. Moreover, the wires 90 are made up of a pair of electrical lead wires. The invention discloses that the wires 90 are bonded to the inside of the thermal contact surface 30, which, in turn, precludes the unwanted heat flow from the wires 30. This allows the wires 30 to approach an equilibrium temperature quickly, so that the thermal sensor 40 reaches thermal equilibrium more rapidly and up to 50% of the measurement time is saved. Hence, the disposable temperature probe does not require a build-in heater as taught by the prior art.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A thermometer comprising:
a disposable temperature probe comprising:
a hollow tip member having a thermal contact surface surrounding a hollow cavity;
a thermal sensor mounted on the inside of the thermal contact surface of the hollow tip member, for sensing the temperature of the thermal contact surface and generating a temperature signal; and
a transmission means connected to the thermal sensor for transmitting the temperature signal, wherein at least a portion of the transmission means within the hollow cavity is bonded to the inside of the thermal contact surface;
a temperature recorder comprising:
a slot for installing the disposable temperature probe; and
a display means connected to the transmission means for displaying a temperature corresponding to the temperature signal.

2. The thermometer as recited in claim 1 wherein the disposable temperature probe is a flat shape.

3. The thermometer as recited in claim 2 wherein the disposable temperature probe has a thickness of substantially 0.3 mm.

4. The thermometer as recited in claim 1 wherein the transmission means comprises:
a set of wires arranged in a hollow tip member; and
a connector electrically coupled to the set of wires and extended out of the disposable temperature probe, for connecting to the temperature recorder.

5. The thermometer as recited in claim 4 wherein the temperature recorder further comprises a latch for fastening the disposable temperature probe.

6. The thermometer as recited in claim 5 wherein the latch comprises:
a lock switch;
a lock unit having a base portion, an upper portion, and a bending portion connected between the base and the upper portions, wherein the bending portion comprises a wire hole for allowing the connector of the transmission means to be passed through the bending portion;
a pivot rod covered with a sleeve, wherein the sleeve is coupled with the upper portion of the lock unit;
a driving arm inserted into the sleeve and engaged with the pivot rod; and
a pressing portion extended from the driving arm for bearing the lock switch.

7. The thermometer as recited in claim 6 wherein the driving arm, the upper and the bending portions of the lock unit are connected together at a contact end to form a fulcrum, and when the lock switch is pushed, the pressing portion is moved downward to lift the pivot rod engaged with the driving arm by the fulcrum and the bending portion of the lock unit is bended, thereby forming an aperture between the upper and the base portions of the lock unit.

8. A disposable temperature probe comprising:
a flat hollow tip member having a thermal contact surface surrounding a hollow cavity;
a thermal sensor mounted on the inside of the thermal contact surface of the hollow tip member, for sensing the temperature of the thermal contact surface and generating a temperature signal;
a set of wires connected to the thermal sensor for passing the temperature signal, wherein at least a portion of the transmission means within the hollow cavity is bonded to the inside of the thermal contact surface; and
a connector electrically coupled to the transmission means and disposed on the flat hollow tip member externally.
